(19) United States
(12) Patent Application Publication
(10) Pub. No.: US 2007/0071951 A1
(43) Pub. Date: Mar. 29, 2007

(54) Authenticatable plastic material, articles, and methods for their fabrication

(76) Inventors: James Grande, Ballston Lake, NY (US); Radislav A. Potyrailo, Niskayuna, NY (US); Philippe Schottland, West Chester, OH (US); Marc Wisnudel, Clifton Park, NY (US)

Correspondence Address: CANTOR COLBURN LLP - GE PLASTICS - SMITH, 55 GRIFFIN RD SOUTH, BLOOMFIELD, CT, 06002, US

(21) Appl. No.: 11/238,188

(22) Filed: Sep. 29, 2005

(51) Int. Cl. B44C 1/17

(52) U.S. Cl. 428/195.1

(57) ABSTRACT

Disclosed herein are randomly marked plastic materials and articles, and methods for their fabrication. In one embodiment, a randomly marked article can comprise: a random distribution of markings within a substrate, and machine readable data and/or a data layer capable of comprising machine readable data. The substrate was formed a first plastic and a second plastic, wherein the first plastic and the second plastic comprise a sufficient difference in a property to cause the random distribution. In one embodiment, a method for fabricating an article, comprises: combining a taggant with a first plastic to form a tagged plastic; molding the article from the tagged plastic and a second plastic, wherein the article comprises a random distribution of the taggant; and mapping taggant in the article to form a map.

### BACKGROUND OF THE INVENTION

Automated identification of plastic compositions is very desirable for a variety of applications, such as recycling, tracking the manufacturing source, antipiracy protection, and others. A variety of identification methods of plastic materials are known, including x-ray and infrared spectroscopy. The use of tags in plastic materials is also known, such as uniformly distributed fluorescent dyes. A disadvantage to the use of the dyes is that incorrect signals can be produced if any of the dyes age or leach under normal use conditions (e.g., exposure to ultraviolet (UV) light, high ambient temperature, etc). In addition, additives in polymers can alter the ratio of fluorescence intensities. Fluorescence lifetime of an embedded dye was also used for the identification purposes. In these systems, the uniform distribution of the dyes was important to enable the measurement tools to correctly identify the presence of the dye and its level. A non-uniform distribution of dyes is highly undesirable because of the high level of associated errors.

There continues to be a need for authenticatable plastic materials, articles, and methods for their fabrication.

### SUMMARY

This disclosure relates to randomly marked plastic materials and articles, and methods for their fabrication.

In one embodiment, a randomly marked article can comprise: a random distribution of markings within a substrate, and machine readable data and/or a data layer capable of comprising machine readable data. The substrate was formed a first plastic and a second plastic, wherein the first plastic and the second plastic comprise a sufficient difference in a property to cause the random distribution.

In one embodiment, a method for fabricating an article, comprises: combining a taggant with a first plastic to form a tagged plastic; molding the article from the tagged plastic and a second plastic, wherein the article comprises a random distribution of the taggant; and mapping taggant in the article to form a map.

In one embodiment, a method for fabricating a data storage medium disk substrate comprises: combining a taggant with a first plastic to form a tagged plastic; and molding the disk substrate from the tagged plastic and a second plastic. The disk substrate comprises a random distribution of the taggant. The taggant is detectable at a laser wavelength used to read from and/or write to the data storage disk.

In one embodiment, a method for authenticating an article comprises: illuminating the article, and if an emission is detected, comparing the detected emission to the map to determine if the article is authentic. An authentic article comprises a random distribution of markings whose locations have been mapped, wherein the markings are detectable at a wavelength, and wherein the article is illuminated at the wavelength.

The above described and other features are exemplified by the following figures and detailed description.

### BRIEF DESCRIPTION OF THE DRAWINGS

Refer now to the figures, which are exemplary embodiments, and wherein the like elements are numbered alike.

FIGS. 1-3 are “marble” streaking markings of Chips 3, 4, and 5, respectively, produced with a blue colorant Solvent Blue 104.

FIGS. 4-6 are pictures of “marble” streaking markings by color inversion illustrating streaking markings of Chips 3, 4, and 5, respectively, produced with a blue colorant Solvent Blue 104.

FIG. 7 is a graphical representation of the dependence of area coverage of high optical density regions as a function of chip number for Chips 3, 4, and 5.

FIG. 8 is a graphical representation of the dependence of feature density of high optical density regions as a function of chip number for Chips 3, 4, and 5.

FIG. 9 is a picture of “marble” streaking markings in a molded optical disk.

FIG. 10 is a picture of a visualization of “marble” streaking markings in a molded optical disk by color inversion.

FIG. 11 illustrates reflected light imaging of randomly incorporated optical dye in an optical disk through 645 nm to 655 nm optical bandpass filters.

FIG. 12 illustrates reflected light imaging of randomly incorporated optical dye in an optical disk through 735 nm to 765 nm optical bandpass filters.

FIG. 13 illustrates fluorescence light imaging of randomly incorporated optical dye in an optical disk through 735 nm to 765 nm optical bandpass filters under 633 nm laser excitation.

FIG. 14 illustrates fluorescence light imaging of randomly incorporated optical dye in an optical disk through 775 nm to 825 nm optical bandpass filters under 633 nm laser excitation.

FIG. 15 is a top view of a disk with no color coating.

FIG. 16 is a graphical representation of how the reflectivity (clear) values were sensitive to the number of blue spots on the disk.

FIG. 17 is a graphical representation of how the red values were sensitive to the number of blue spots on the disk.

FIG. 18 is a top view of a disk with multiple blue spots.

FIG. 19 is a graphical representation of the unique features of several DVDs.

FIG. 20 is a graphical comparison of signatures from two DVDs illustrating the details of the uniqueness of the signatures.

FIG. 21 is a graphical comparison of signatures from one DVD taken at four different radial positions.

FIG. 22 a graphical representation of the results of the PCA analysis of 13 DVDs measured at the initial laser location position.

### DETAILED DESCRIPTION

It is noted that the terms “first,” “second,” etc, “primary,” “secondary”, etc., and the like, herein do not denote any amount, order, or importance, but rather are used to distinguish one element from another, and the terms “a” and “an” herein do not denote a limitation of quantity, but rather denote the presence of at least one of the referenced item. Additionally, all ranges disclosed herein are inclusive and combinable (e.g., the ranges of “up to 25 wt %, with 5 wt % to 20 wt % desired,” are inclusive of the endpoints and all intermediate values of the ranges of “5 wt % to 25 wt %,” etc.). The modifier “about” used in connection with a quantity is inclusive of the stated value and has the meaning dictated by the context (e.g., includes the degree of error associated with measurement of the particular quantity). The suffix “(s)” as used herein is intended to include both the singular and the plural of the term that it modifies, thereby including one or more of that term (e.g., the colorant(s) includes one or more colorants).

Disclosed herein are authenticatable materials, articles, and methods for their fabrication, or, more specifically, methods for non-destructive authentication of plastic articles such as casino chips, information articles (e.g., media articles (such as optical disks, and the like), personal identification articles (such as license (e.g., driver's license, professional license (e.g., license showing professional status (doctor, lawyer, electrician, taxi driver, badge (police, firefighter, agent, and so forth)), visa, credit card, debit card, passport, membership card, employment identification card, and the like), and the like), medical articles (e.g., plastic containers, plastic instruments, and the like), entertainment articles, plastic housings (e.g., housings of communication device (such as phones), and the like), and any other articles, such as other articles that suffer from counterfeiting. Exemplary media articles, e.g., data storage media, that can employ the random marking include, for example, optical and magneto-optical media formats, such as compact discs (CD) (e.g., recordable compact disk (CD-R), rewritable compact disk (CD-RW), and the like), magneto-optical discs, digital versatile discs (e.g., DVD-5, DVD-9, DVD-10, DVD-18, DVD-R, DVD-RW, DVD+RW, DVD-RAM, HD-DVD, and the like), Blu-Ray discs, enhanced video discs (EVD), and recordable and re-writable Blu-Ray discs, and the like, as well as combinations comprising at least one of the foregoing (e.g., hybrid disks comprising, for example, CD and DVD formatting).

The authenticatable materials and articles employ non-homogenous, random markings. The random markings can be formed, for example, by incorporating a taggant into a first plastic(s) and combining the first plastic with a second plastic(s), wherein the first plastic and the second plastic, under the processing conditions (e.g., molding temperature, mixing conditions, and the like) for the material/article formation, have different melt flow properties, different weight average molecular weights (M_{w}), and/or different glass transition temperatures, or a combination comprising at least one of the foregoing differences. To avoid degradation of the taggant during processing of the plastic and/or formation of an article, the taggant can be disposed in the plastic having a higher melting temperature.

When a difference in glass transition temperature (T_{g}) is employed, the difference should be sufficient to attain a random distribution of the taggant; i.e., a non-homogenous distribution made without reproducibility of the specific distribution, without a definite pattern and without an attempt for uniformity. For example, for some plastics, such as polycarbonate matrices, a difference in glass transition temperature greater than or equal to about ±30° C. is sufficient to provide random markings in standard molding conditions (e.g., an extrusion barrel temperature of about 300° C.). More specifically, the difference in glass transition temperature can be greater than or equal to about ±30° C., or, even more specifically, greater than or equal to about ±50° C. It is noted that with some matrices, the difference in glass transition temperature that will attain a random distribution may be lower than ±30° C.

When relying upon a difference in melt viscosity rate, again, the difference is dependent upon the specific materials employed and should be sufficient to attain the random distribution of the taggant. For example, for optical quality (OQ) polycarbonate, a difference in melt flow range of greater than or equal to about ±30 g/10 min (at 300° C. using a 1.2 kg load in accordance with ASTM D1238-01e1/ISO 1133-1991) can create a random marking, or, more specifically, a difference of greater than or equal to about ±45 g/10 min, and even more specifically, greater than or equal to about ±60 g/10 min.

When relying upon a difference in weight average molecular weight, the difference is dependent upon the specific materials employed and should be sufficient to attain the random distribution of the taggant. For example, for optical quality (OQ) polycarbonate, a difference in M_{w} of greater than or equal to about ±5,000 atomic mass units (amu) can create a random marking, or, more specifically, a difference of greater than or equal to about ±10,000 amu, and even more specifically, greater than or equal to about ±20,000 amu. Unless specifically specified otherwise, all molecular weight determinations herein are performed using gel permeation chromatography (GPC), using a crosslinked styrene-divinylbenzene column and calibrated to polycarbonate references. Samples are prepared at a concentration of about 1 milligram per milliliter (mg/ml), and are eluted at a flow rate of about 18 milliliter per minute (ml/min).

The authenticatable material can comprise a plastic. Examples of plastics include, amorphous, crystalline, and/or semi-crystalline thermoplastic materials, such as: polyvinyl chloride, polyolefins (including linear and cyclic polyolefins and including polyethylene, chlorinated polyethylene, polypropylene, and the like), polyesters (including polyethylene terephthalate, polybutylene terephthalate, polycyclohexylmethylene terephthalate, and the like), polyamides, polysulfones (including hydrogenated polysulfones, and the like), polyimides, polyether imides, polyether sulfones, polyphenylene sulfides, polyphenylene oxide, polyphenylene oxide/polystyrene blends (Noryl™), polyether ketones, polyether ether ketones, ABS resins, polystyrenes (including hydrogenated polystyrenes, syndiotactic and atactic polystyrenes, polycyclohexyl ethylene, styrene-co-acrylonitrile, styrene-co-maleic anhydride, and the like), polybutadiene, polyacrylates (including polymethylmethacrylate, methyl methacrylate-polyimide copolymers, and the like), polyacrylonitrile, polyacetals, polycarbonates (including those derived from 1,1-bis(4-hydroxyphenyl) methane; 1,1-bis(4-hydroxyphenyl) ethane; 2,2-bis(4-hydroxyphenyl) propane; 2,2-bis(4-hydroxyphenyl) butane; 2,2-bis(4-hydroxyphenyl) octane; 1,1-bis(4-hydroxyphenyl) propane; 1,1-bis(4-hydroxyphenyl) n-butane; bis(4-hydroxyphenyl) phenylmethane; 2,2-bis(4-hydroxy-3-methylphenyl) propane; 1,1-bis(4-hydroxy-t-butylphenyl) propane; bis(hydroxyaryl) alkanes such as 2,2-bis(4-hydroxy-3-bromophenyl) propane; 1,1-bis(4-hydroxyphenyl) cyclopentane; 9,9′-bis(4-hydroxyphenyl) fluorene; 9,9′-bis(4-hydroxy-3-methylphenyl) fluorene; 4,4′-biphenol; and bis(hydroxyaryl) cycloalkanes such as 1,1-bis(4-hydroxyphenyl) cyclohexane and 1,1-bis(4-hydroxy-3-methylphenyl)cyclohexane), polyarylene ethers (e.g., polyphenylene ethers (including those derived from 2,6-dimethylphenol and copolymers with 2,3,6-trimethylphenol, and the like)), ethylene-vinyl acetate copolymers, polyvinyl acetate, liquid crystal polymers, ethylene-tetrafluoroethylene copolymer, aromatic polyesters, polyvinyl fluoride, polyvinylidene fluoride, polyvinylidene chloride, polytetrafluorethylene, as well as thermosetting resins such as epoxy, phenolic, alkyds, polyester, polyimide, polyurethane, silicones (e.g., mineral filled silicone, silicone dioxide (e.g., fumed silica)), bis-maleimides, cyanate esters, vinyl, and benzocyclobutene resins, in addition to combinations, blends, copolymers, mixtures, reaction products, and composites comprising at least one of the foregoing.

The authenticatable material further comprises a tag (also referred to herein as “taggant”). Tags are of any nature where the tags retain at least one property that is detectable after forming the material and, if applicable, the article (e.g., after an extrusion and/or molding processing). For example, if the tag is in a disk substrate, it can be detectable at a laser wavelength employed to read from and/or write to the data storage disk. Examples of tags include spectroscopic, magnetic, dialectic, morphological, and the like, as well as combinations comprising at least one of the foregoing tags. For example, the taggant can comprise an optical signature at greater than or equal to 1 wavelength, or, more specifically, at greater than or equal to 2 wavelengths. The taggant can be a fluorescent dye, or the like, capable of producing a detectable photoluminescence when excited. Optionally, the plastic can exhibit intrinsic photoluminescence such that it is not necessary to add a taggant in order to produce a detectable photoluminescence. For example, the Fries Product may be detected in polycarbonate by use of fluorescence spectroscopy (e.g., see U.S. patent application Ser. No. 20050095715A1). In an embodiment, the fluorescent monomer is copolymerized into the backbone or endcap of the polymer. Some possible tags include organic fluorophore molecules, inorganic phosphor particles, inorganic nanoparticles, metallic nanoparticles, semiconductor nanoparticles, organic nanoparticles, hybrid nanoparticles (e.g., particles that contain different materials of their core-shell structures), and the like, as well as combinations comprising at least one of the foregoing. If the tag is use in a data storage medium, e.g., an optical or magneto-optic disk, the tag should not be a material and/or should not be at a loading that, at the read-back wavelength, creates uncorrectable errors in the disk.

Optionally, the media can comprise an optically variable tag, e.g., a compound that has a fluorescence emission that changes in fluorescence intensity and/or wavelength as a function of time. In one embodiment, the media may be designed to be evaluated several times, i.e., the authenticating signal is repeatable, while in other embodiments the authenticating signal may be capable of evaluation only once due to the use of optically variable tags that, for example, degrade after one or more authentication sequences. In one exemplary embodiment, the authenticatable polymer will comprise an optically variable tag that can be identified and optionally authenticated multiple times, i.e., for example, at various points during manufacture, and/or during use in a media system (e.g., optical device, media player, or the like) or a kiosk.

Suitable optically variable tags are generally fluorescent or luminescent materials that are selected to be chemically compatible with the polymer and have a heat stability consistent with engineering plastics compounding and in particular with the processing conditions of the portion of the media in which they are included (e.g., the polymer substrate).

Possible optically variable tags include oxadiazole derivatives, luminescent conjugated polymers, and the like. Illustrative examples of suitable luminescent conjugated polymers are blue emitting luminescent polymers, such as poly-paraphenylenevinylene derivatives. Illustrative examples of suitable oxadiazole derivatives include oxadiazole derivatives substituted with a biphenyl or substituted biphenyl in the 2-position and with a phenyl derivative in the 5-position; for example, tert-butyl phenyl oxadiazole, bis(biphenylyl) oxadiazole, as well as mixtures comprising at least one of these tags.

Alternatively, and or in addition, the tag may be a non-optically variable compound. Non-optically variable compounds comprise luminescent tags, and optionally luminescent tags that are selected to enhance the signal from optically variable tags when used in combination. Luminescent tags include an organic fluorophore, an inorganic fluorophore, an organometallic fluorophore, a phosphorescent material, a luminescent material, a semiconducting nanoparticle, and so forth, as well as combinations comprising at least one of the foregoing tags.

In an exemplary embodiment, the luminescent tags are selected from classes of dyes that exhibit high robustness against ambient environmental conditions and temperature stability of greater than or equal to about 350° C., or specifically, greater than or equal to about 375° C., and more specifically, greater than or equal to about 400° C. It is desirable to have optically variable tags and/or luminescent tags hidden behind the matrix absorption. The matrix absorption is the absorption from the media (e.g., in the substrate) or from any additive or colorant present in the substrate. Alternatively, it is desirable to have optically variable tags and/or luminescent tags with a peak excitation wavelength outside the visible range (e.g., in the ultraviolet range) and a peak emission in the visible or in the near infrared region of the spectrum. When the difference between the excitation and the emission peak is greater than or equal to about 50 nm, these compounds are usually referred to as long (positive) Stokes shift dyes. In an exemplary embodiment, the luminescent tags are selected from the classes of long stokes shift dyes that are excited by long ultraviolet wavelengths and emit in the visible.

Illustrative luminescent tags include fluorescent tags for example, dyes such as polyazaindacenes and/or coumarins (including those set forth in U.S. Pat. No. 5,573,909); lanthanide complexes; hydrocarbon and substituted hydrocarbon dyes; polycyclic aromatic hydrocarbons; scintillation dyes (e.g., oxazoles and oxadiazoles); aryl- and heteroaryl-substituted polyolefins (C₂-C₈ olefin portion); carbocyanine dyes; phthalocyanine dyes and pigments; oxazine dyes; carbostyryl dyes; porphyrin dyes; acridine dyes; anthraquinone dyes; anthrapyridone dyes; naphtalimide dyes; benzimidazole derivatives; arylmethane dyes; azo dyes; diazonium dyes; nitro dyes; quinone imine dyes; tetrazolium dyes; thiazole dyes; perylene dyes; perinone dyes; bis-benzoxazolylthiophene (BBOT); xanthene and thioxanthene dyes; indigoid and thioindigoid dyes; chromones dyes; flavones dyes; and so forth, as well as derivatives of at least one of the foregoing tags disclosed herein, and combinations comprising at least one of the foregoing tags disclosed herein. Luminescent tags also include anti-Stokes shift dyes that absorb in the near infrared wavelength and emit in the visible wavelength.

The following is a partial list of some fluorescent and/or luminescent dyes: 5-amino-9-diethyliminobenzo(a)phenoxazonium perchlorate7-amino-4-methylcarbostyryl, 7-amino-4-methylcoumarin, 7-amino-4-trifluoromethylcoumarin, 3-(2′-benzimidazolyl)-7-N,N-diethylaminocoumarin, 3-(2′-benzothiazolyl)-7-diethylaminocoumarin, 2-(4-biphenylyl)-5-(4-t-butylphenyl)-1,3,4-oxadiazole, 2-(4-biphenylyl)-5-phenyl-1,3,4-oxadiazole, 2-(4-biphenyl)-6-phenylbenzoxazole-1,3,2,5-bis-(4-biphenylyl)-1,3,4-oxadiazole, 2,5-bis-(4-biphenylyl)-oxazole, 4,4′-bis-(2-butyloctyloxy)-p-quaterphenyl, p-bis(o-methylstyryl)-benzene, 5,9-diaminobenzo(a)phenoxazonium perchlorate, 4-dicyanomethylene-2-methyl-6-(p-dimethylaminostyryl)-4H-pyran, 1,1′-diethyl-2,2′-carbocyanine iodide, 1,1′-diethyl-4,4′-carbocyanine iodide, 3,3′-diethyl-4,4′,5,5′-dibenzothiatricarbocyanine iodide, 1,1′-diethyl-4,4′-dicarbocyanine iodide, 1,1′-diethyl-2,2′-dicarbocyanine iodide, 3,3′-diethyl-9,11-neopentylenethiatricarbocyanine iodide, 1,3′-diethyl-4,2′-quinolyloxacarbocyanine iodide, 1,3′-diethyl-4,2′-quinolylthiacarbocyanine iodide, 3-diethylamino-7-diethyliminophenoxazonium perchlorate, 7-diethylamino-4-methylcoumarin, 7-diethylamino-4-trifluoromethylcoumarin, 7-diethylaminocoumarin, 3,3′-diethyloxadicarbocyanine iodide, 3,3′-diethylthiacarbocyanine iodide, 3,3′-diethylthiadicarbocyanine iodide, 3,3′-diethylthiatricarbocyanine iodide, 4,6-dimethyl-7-ethylaminocoumarin, 2,2′-dimethyl-p-quaterphenyl, 2,2-dimethyl-p-terphenyl, 7-dimethylamino-1-methyl-4-methoxy-8-azaquinolone-2,7-dimethylamino-4-methylquinolone-2,7-dimethylamino-4-trifluoromethylcoumarin, 2-(4-(4-dimethylaminophenyl)-1,3-butadienyl)-3-ethylbenzothiazolium perchlorate, 2-(6-(p-dimethylaminophenyl)-2,4-neopentylene-1,3,5-hexatrienyl)-3-methylbenzothiazolium perchlorate, 2-(4-(p-dimethylaminophenyl)-1,3-butadienyl)-1,3,3-trimethyl-3H-indolium perchlorate, 3,3′-dimethyloxatricarbocyanine Iodide, 2,5-diphenylfuran, 2,5-diphenyloxazole, 4,4′-diphenylstilbene, 1-ethyl-4-(4-(p-dimethylaminophenyl)-1,3-butadienyl)-pyridinium perchlorate, 1-ethyl-2-(4-(p-dimethylaminophenyl)-1,3-butadienyl)-pyridinium perchlorate, 1-ethyl-4-(4-(p-dimethylaminophenyl)-1,3-butadienyl)-quinolium perchlorate, 3-ethylamino-7-ethylimino-2,8-dimethylphenoxazin-5-ium perchlorate, 9-ethylamino-5-ethylamino-10-methyl-5H-benzo(a)phenoxazonium perchlorate, 7-ethylamino-6-methyl-4-trifluoromethylcoumarin, 7-ethylamino-4-trifluoromethylcoumarin, 1,1′,3,3,3′,3′-hexamethyl-4,4′,5,5′-dibenzo-2,2′-indotricarboccyanine iodide, 1,1′,3,3,3′,3′-hexamethylindodicarbocyanine iodide, 1,1′,3,3,3′,3′-hexamethylindotricarbocyanine iodide, 2-methyl-5-t-butyl-p-quaterphenyl, N-methyl-4-trifluoromethylpiperidino-<3,2-g>coumarin, 3-(2′-N-methylbenzimidazolyl)-7-N,N-diethylaminocoumarin, 2-(1-naphthyl)-5-phenyloxazole, 2,2′-p-phenylen-bis(5-phenyloxazole), 3,5,3′″″,5′″″-tetra-t-butyl-p-sexiphenyl, 3,5,3′″″,5′″″-tetra-t-butyl-p-quinquephenyl, 2,3,5,6-1H,4H-tetrahydro-9-acetylquinolizino-<9,9a, 1-gh>coumarin, 2,3,5,6-1H,4H-tetrahydro-9-carboethoxyquinolizino-<9,9a, 1-gh>coumarin, 2,3,5,6-1H,4H-tetrahydro-8-methylquinolizino-<9,9a, 1-gh>coumarin, 2,3,5,6-1H,4H-tetrahydro-9-(3-pyridyl)-quinolizino-<9,9a, 1-gh>coumarin, 2,3,5,6-1H,4H-tetrahydro-8-trifluoromethylquinolizino-<9,9a,1-gh>coumarin, 2,3,5,6-1H,4H-tetrahydroquinolizino-<9,9a,1-gh>coumarin, 3,3′,2″,3′″-tetramethyl-p-quaterphenyl, 2,5,2′″″,5′″-Tetramethyl-p-quinquephenyl, p-terphenyl, p-quaterphenyl, Nile Red, Rhodamine 700, Oxazine 750, Rhodamine 800, IR 125, IR 144, IR 140, IR 132, IR 26, IR5, diphenylhexatriene, diphenylbutadiene, tetraphenylbutadiene, naphthalene, anthracene, 9,10-diphenylanthracene, pyrene, chrysene, rubrene, coronene, phenanthrene, and the like.

Luminescent tags may include luminescent nanoparticles having a size (measured along a major diameter) of about 1 nanometer (nm) to about 50 nanometers. Exemplary luminescent nanoparticles include rare earth aluminates (such as strontium aluminates doped with europium and dysprosium, and the like); semi-conducting nanoparticles (such as CdS, ZnS, Cd₃P₂, PbS, and the like); and the like, as well as combinations comprising at least one of the foregoing. In one embodiment, fluorescent tags such as perylenes such as anthra[2,1,9-def:6,5,10-d′e′f′]diisoquinoline-1,3,8,10(2H,9H)-tetrone, 2,9-bis[2,6-bis(1-methyethyl)phenyl]-5,6,12,13-tetraphenoxy are utilized as the luminescent tags.

It is understood that the authenticatable material and article can comprise combinations of any of the above tags, as well as combinations comprising at least one of any of the above tags.

The concentration of the luminescent tags depends on the quantum efficiency of the tag, excitation and emission wavelengths, and employed detection techniques, and can be present in an amount of about 10⁻¹⁸ weight percent (wt %) to about 2 wt %, based upon the total weight of the substrate (or layer in which the tag is present), optionally in an amount of about 10⁻¹⁵ wt % to about 0.5 wt %, or, more specifically, about 10⁻¹² wt % to about 0.05 wt %.

To further enhance authentication, the plastic compositions may also contain colorants. These colorants may, for example, impart a specific appearance to the tagged material or tagged article (e.g., data storage media, disk) under normal lighting conditions (e.g., daylight). To enable facile and accurate authentication of the storage media, it is desirable that any colorants used do not interfere with the photoluminescent emissions. For example, the colorant could exhibit no or only very weak fluorescence under UV excitation compared to the taggant (e.g., fluorescent dye). Suitable colorants may include non-fluorescent derivatives of the following dye families: anthraquinones, methine, perinones, azo, anthrapyridones, quinophtalones, and the like, as well as combinations comprising at least one of the foregoing colorants.

As noted above, the authenticatable materials and articles employ random markings. Incorporating a taggant into a plastic and combining the plastic with another plastic having different properties under the fabrication conditions can form the random markings. For example, the plastics can have different melt flow properties, different weight average molecular weights (M_{w}), and/or different glass transition temperatures, at the molding conditions employed to attain the molded article with the desired random marking. It is understood that different taggants could be disposed in each plastic and the plastics could be combined, so long as the random marking is generated.

If the article is a storage media (a data storage disk), it can comprise various layers in addition to the substrate(s), with the random marking disposed in any of various layers, e.g., a substrate, coating, bonding layer, and/or the like. A data storage media can comprise substrate(s), protective layer(s), dielectric layer(s), insulating layer(s), data storage portions(s) (e.g., magnetic, magneto-optic, optic, and the like; wherein the portion may be a layer of material and/or surface features (pits, grooves, lands, and the like)), protective layer(s), adhesive layer(s), lubricating layer(s), separator layer(s), ultra-violet (UV) inhibitor layer(s), moisture barrier layer(s), ductility layer(s), and the like, as well as combinations comprising at least one of the foregoing, and others.

As stated above, the information which is to be stored on the data storage medium can be disposed (e.g., imprinted, molded, or the like) directly onto the surface of the substrate and/or a layer thereon (e.g., the data layer), and/or stored in a photo-, thermal-, or magnetically-definable medium which has been deposited onto the surface of the substrate layer. In other words, the data can be machine readable data (e.g., data readable with an optical reader, media player, and so forth), and the data layer can be capable of comprising machine readable data (e.g., audio and/or visual information). The data storage layer(s) may comprise any material capable of storing retrievable data, such as an optical layer, magnetic layer, or a magneto-optic layer, having a thickness of less than or equal to about 600 Angstroms (Å), or, more specifically, a thickness less than or equal to about 300 Å. Possible data storage layers include, but are not limited to, media oxides (such as metal oxides, silicone oxide, and the like), rare earth element—transition metal alloys, nickel, cobalt, chromium, tantalum, platinum, terbium, gadolinium, iron, boron, and others, organic dyes (e.g., cyanine type dyes, phthalocyanine type dyes, and the like), inorganic phase change compounds (e.g., TeSeSn, InAgSb, and the like), and so forth, alloys comprising at least one of the foregoing, and combinations comprising at least one of the foregoing.

The protective layer(s), which can protect against dust, oils, and other contaminants, abrasions, and the like, can have a thickness of about 10 Å to about 200 micrometers (μm), or, more specifically, in some applications, a thickness of about 40 μm to about 175 μm, or, even more specifically, about 75 μm to about 125 μm. In other applications, the thickness can be less than or equal to about 300 Å, or, more specifically, less than or equal to about 100 Å. The thickness of the protective layer(s) can be determined, at least in part, by the type of read/write mechanism employed, e.g., magnetic, optic, or magneto-optic. Possible protective layers include anti-corrosive materials such as nitrides (e.g., silicon nitrides, aluminum nitrides, and the like), carbides (e.g., silicon carbide, and others), protective oxides (e.g., silicon dioxide, and the like), polymeric materials (e.g., polyacrylates, and/or polycarbonates), carbon film (e.g., diamond, diamond-like carbon, etc.), among others, and reaction products and combinations comprising at least one of the foregoing. For example, the protective layer can comprise UV curable silicone acrylate (functionalized silica), and the like.

The dielectric layer(s), which is disposed on one or both sides of the data storage layer and is often employed as a heat controller, can typically have a thickness of up to or exceeding about 1,000 Å and as low as about 200 Å. Possible dielectric layers include nitrides (e.g., silicon nitride, aluminum nitride, and others); oxides (e.g., aluminum oxide); carbides (e.g., silicon carbide); and alloys and combinations comprising at least one of the foregoing, among other materials compatible within the environment and preferably, not reactive with the surrounding layers.

The reflective layer(s) should have a sufficient thickness to reflect a sufficient amount of energy to enable data retrieval. Typically the reflective layer(s) can have a thickness of less than or equal to about 900 Å, or, more specifically, a thickness of about 300 Å to about 600 Å. Possible reflective layers include any material capable of reflecting the particular energy field, including metals (e.g., aluminum, silver, gold, titanium, and alloys and combinations comprising at least one of the foregoing, and others). In addition to the data storage layer(s), dielectric layer(s), protective layer(s) and reflective layer(s), other layer(s) can be employed such as a lubrication layer(s) and others. Useful lubrication layer(s) include fluoro compounds, especially fluoro oils and greases, and the like.

The data storage medium can be a first surface medium and/or a read through medium. Possible medium designs comprise the substrate with the random distribution of the taggant therein, data and/or a data layer, a reflective layer(s), and protective layer(s). The reflective layer can be disposed on a surface of the substrate comprising pits, lands, grooves, and/or other surface features. If a data layer(s) is employed, the reflective layer can be disposed between the data layer(s) and the substrate. The protective layer, as well as any lubrication layer(s), can be disposed on a side of the data and/or data layer(s) opposite the substrate. Dielectric layer(s) can be disposed on one or both sides of the data layer(s).

Methods of fabricating articles comprising the random marking can comprise mixing a taggant with a first plastic and forming, for example, pellets, powder, and/or the like, to form the tagged plastic. The tagged plastic can then be combined with the second plastic(s). Combining can comprise (i) co-extruding the tagged plastic and the second plastic to form pellets with non-homogenous markings, (ii) mixing the tagged pellets with the second plastic pellets and then molding the mixed pellets to form an article with random markings, (iii) combining the tagged plastic and the second plastic in the molding machine, (iv) laminating a plastic sheet or film with non-homogenous markings onto an article, and so forth. For example, the tagged plastic and second plastic can be introduced into a mold (e.g., injection molded, compression molded, blow-molded, etc.), to form an article comprising a random marking, wherein the plastics are not actively mixed prior to introduction to the mold cavity. In other words, the plastics can be introduced to the mold cavity through a common port or through separate ports without mixing in an extruder or the like prior to introduction to the molding machine.

In order to attain the desired random markings, the fabrication parameters (e.g., molding temperature, extrusion conditions (temperature, shear, and the like)) are chosen to utilize the differences in properties between the tagged plastic and the second plastic; e.g., to attain a difference in viscosity of molten polymer; e.g., greater than 500 poise at a shear of 1,000 sec⁻¹ (during injection molding). In one embodiment, the two types of plastic (the tagged plastic and the second plastic) are both in the rubbery phase at the extrusion and molding temperatures (above or well above the glass transition temperature (T_{g})). In that case, it is the difference in viscosity that hinders complete mixing and results in the non-homogenous marks. Non-homogenous marks can also be created by incorporating a second plastic containing a semi-crystalline polymer that does not completely melt at the extrusion or molding temperatures. Additionally, the second plastic can comprise an encapsulated colorant(s) (e.g., the second plastic can be the same material as the first plastic, with the difference being the colorant), wherein the encapsulant ruptures at or near the extrusion or molding temperature resulting in a non-homogeneous dispersion of the colorant.

Once an article with a random marking has been fabricated, it can be reviewed (e.g., scanned, mapped, and/or the like) to identify its unique markings. In one embodiment, an article is scanned during the fabrication process (e.g., a media disk (such as an optical or magneto-optic disk)). In other words, the article is formed and then scanned as part of the fabrication process. An algorithm can be used to map the random markings of the article. For example, a disk can be passed through an optical tester (such as an online tester or a drive) to determine key parameters of the streak markings (e.g., location, intensity, and the like), e.g., using a code that analyzes the images. Since each disk has a specific set of parameters, the key parameters can be used to generate an identifier (e.g., a serial number). The identifier (which can be generated by the algorithm), can also take into account other information (such as an external key that may be present in the form of readable data on the disk). The identifier could, for example, be disposed on the article (e.g., on a label, disposed directly (e.g., printed, imprinted, molded, and/or the like) on the article (e.g., disk), and/or supplied with the article). Then, when a consumer (or counterfeiter) attempts to install the software, copy the music/video/information, or the like, the drive can scan the disk to find the key parameters of the marking (e.g., location, degree of reflectivity change at a particular marking, and the like, as well as combinations comprising at least one of the foregoing), and then ask for the identifier. Failure to provide the identifier, failure to find a marking, and/or locate the marking would stop the installation. This approach may also be used to record the installation (activation of a disk) via an internet transaction where the marking and identifier could be recorded on a central database.

In another embodiment, the randomly marked article can be a personal identification article (e.g., passport, identification card, and the like), wherein the random markings can be scanned given an identifier (e.g., a serial number). That particular identifier can further be associated with personal information (e.g., a picture, fingerprint, and/or the like). Hence, when the personal identification is employed, the identification can be placed in a scanner. Based upon the identifier, the scanner can access a central database to determine the specific marking and personal information that should be on that identification. If the random marking is incorrect (the personal information (picture, finger print) on the identification is not that associated with that particular random marking and/or identifier), a counterfeit product identification could be discovered.

The following examples are merely intended to further illustrate the authenticatable material and articles with random markings, and are not intended to be limiting.

### EXAMPLES

### Example 1

### Molded Polycarbonate Articles with Different Predetermined Levels of Marking

Master batches were prepared using about 0.25 wt % of a blue colorant (Solvent Blue 104) (based upon a total weight of the master batch) compounded into a polycarbonate matrix, namely Lexan® OQ 1030 (commercially available from General Electric Plastics, Pittsfield, Mass.). The master batch also contained a phosphite stabilizer and a mold release additive. Resins with different properties, such as T_{g}, M_{w}, melt flow rate, were used to form the master batches as shown in Table 1. All of the resins in Table 1 are polycarbonate, merely different grades.

TABLE 1

| | | | | | | Capillary |
|---|---|---|---|---|---|---|
| | Description of | | | | | melt |
| | master batch | M_{w} | T_{g} | ηₒ¹ | MFR | viscosity |
| Chip | polycarbonate | (amu) | (° C.) | (poise) | (300° C.) | (Pa-s) |
| 1 | Lexan ® OQ² | 17,800 | 144 | 690 | 65 | 84³ |
| | 1030 | | | | | |
| 2 | Lexan ® | — | 145 | — | 25 | 147³ |
| | HF1110R | | | | | |
| 3 | Lexan ® 104R | 32,700 | 148 | 8,400 | 7 | 722³ |
| 4 | Lexan ® 130 | 37,000 | 150 | 13,200 | 3.5 | 872⁴ |
| 5 | Lexan ® 4701 | — | 180 | — | — | 737⁵ |

¹ηₒ = zero shear rate melt viscosity as measured by parallel plate rheometry at 300° C.
²OQ = optical quality
³Capillary melt viscosity at ˜100 sec⁻¹ at 300° C.
⁴Capillary melt viscosity at ˜100 sec⁻¹ at 320° C.
⁵Capillary melt viscosity at ˜100 sec⁻¹ at 340° C.

The 2 wt % master batch pellets were then blended with 98 wt % Lexan® OQ 1030 pellets to form a blend. Color chips having a stepped thickness (one thick portion with a thickness of 1.2 millimeters (mm) and one thin portion with a thickness of 0.6 mm) were molded using standard molding conditions for OQ1030 resin (e.g., melt temperature 280-320° C.). Color Chips 1 and 2 did not exhibit any visible random marking (e.g., streaking). Chip 3 started to show some low level of streaking. Streaking was very visible in Chips 4 and 5. As can be seen from Table 1, the T_{g} increases going from Chip 1 to Chip 5, therefore the change in T_{g} (i.e., ΔT_{g}) increases from Chip 1 to Chip 5. As a result, the degree of streaking also increases.

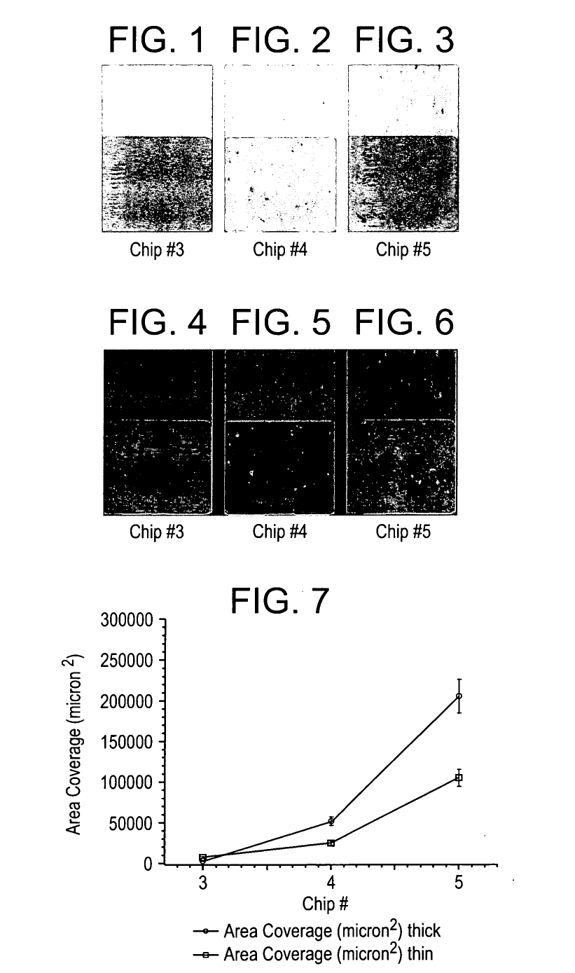

FIGS. 1-3 illustrate the random streaks of Chips 3, 4, and 5, respectively. The streaks are further visualized by inverting the colors as shown in FIGS. 4-6, respectively. As can be seen, at a constant colorant concentration, the greater the ΔT_{g} between the master batch pellets and the resin pellets, the greater the amount of visible streaks.

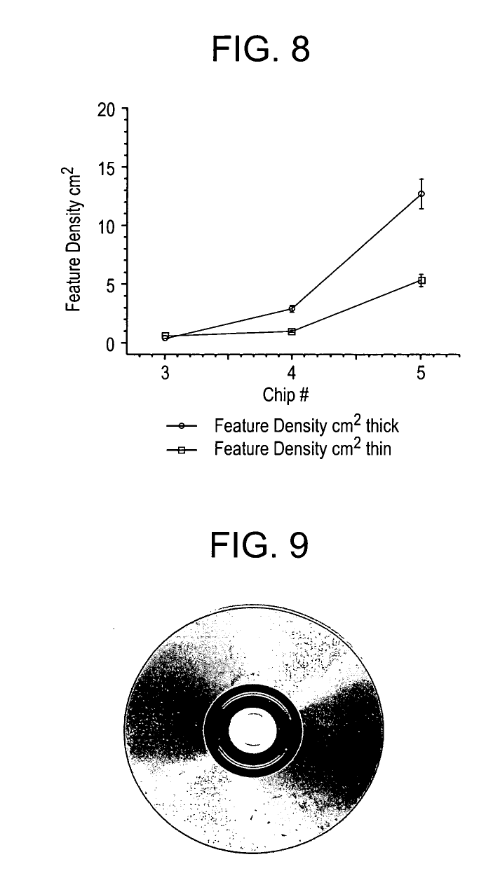

Quantitation of the level of streaking was performed by imaging the chips and applying a standard image analysis software such as Clemex Vision Image Analysis Software (commercially available from Clemex, Inc., Montreal Canada). FIG. 7 illustrates dependence of area coverage (in square micrometers (μm²)) of high optical density regions as a function of chip number for Chips 3, 4, and 5. FIG. 8 illustrates dependence of feature density (i.e., the number of features per square centimeter (cm²)) of high optical density regions as a function of chip number for Chips 3, 4, and 5. These figures show a strong correlation between measured features and the properties of the chip formulations (see Table 1).

### Example 2

### Molded Polycarbonate Optical Disks with Random “Marble”

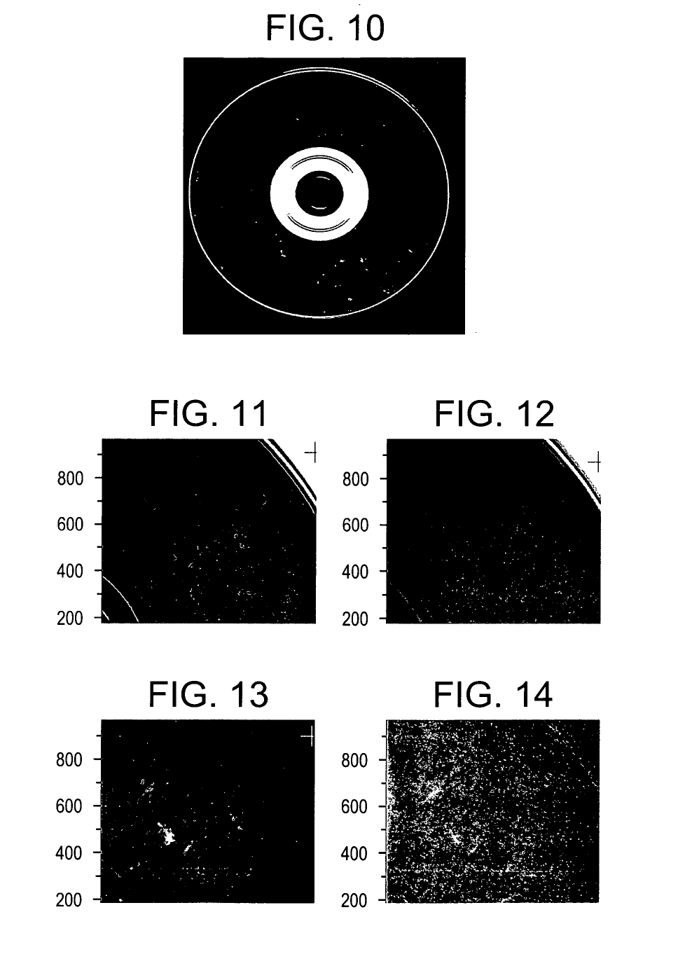

Random markings were further produced in molded optical disks. DVDs were molded with markings depicted in FIG. 9. The markings in molded optical disks are further visualized by inverting the colors as shown in FIG. 10.

Optical features of the markings were further evaluated using reflected light and fluorescence imaging of molded articles. For reflected light imaging at a given wavelength, the article was illuminated with a white light source. Reflected light from the article was captured with a cooled charge coupled device (CCD) camera through an appropriate bandpass optical filter. Several optical filters were installed in a filter holder for automatic filter change during experiments. For fluorescence imaging, a 633 nm light source (He—Ne laser) was used in conjunction with bandpass filters.

A reflected light image through a 645 nm to 655 m bandpass filter is depicted in FIG. 11 which clearly illustrates the random highly absorbing regions on the optical disk. However, it is possible to optically suppress these regions by selecting another spectral region for analysis. A reflected light image through an available 735 nm to 765 nm bandpass filter is depicted in FIG. 12. FIG. 12 clearly illustrates the loss of detection ability of random highly absorbing regions on the optical disk.

Fluorescence analysis was also used for determination of random regions on the optical disk. The optical dye of the random markings had fluorescence detected at 700 nm to 800 nm upon an excitation with a red light source. For example, using a 633 nm laser as an excitation source, fluorescence of random regions was imaged through optical bandpass filters with the peak transmission at 750 nm and 800 nm. The results of these fluorescence imaging experiments are presented in FIG. 13 (735 nm-765 nm) and FIG. 14 (775 nm-825 nm). These results illustrate the capabilities of fluorescence detection of random dye regions on the optical disk.

### Example 3

### CD-R Discs with Color Spots

A series of colored CD-R discs were spotted with dye coatings comprising 10 wt % methylene blue in a poly(hydroxyethyl methacrylate) (pHEMA) matrix, based upon the total weight of the methylene blue and matrix. The matrix comprised a pHEMA/Dowanol PM solution comprising 10 wt % pHEMA, 1 wt % methylene blue, and 89 wt % Dowanol® PM (1-methoxy-2-propanol, commercially available from Sigma-Aldrich, St. Louis, Mo.), based upon the total volume of the solution.

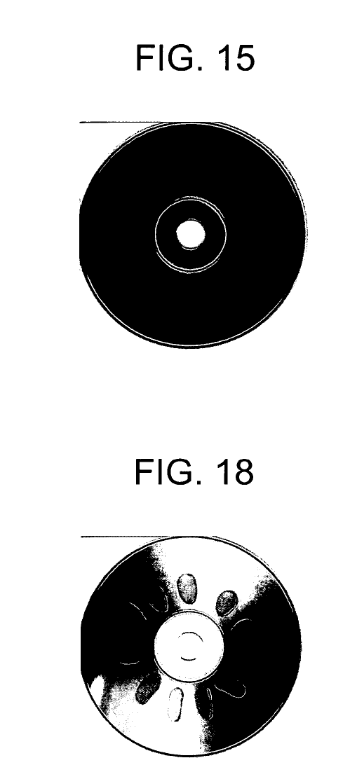

A Plextor Premium CD-RW optical drive modified with an internal red, green, blue (RGB) color sensor with a white light source (light emitting diode (LED)) was used to measure the apparent average color of the disk at a radius of about 28 millimeters (mm) to 34 mm as it was spun at 2,000 revolutions per minute (rpm) in the drive. An uncoated disk (FIG. 15) was found to have the following RGB values: R=258, B=104, G=213, with an overall reflectivity (using an unfiltered photodiode) of C=662.

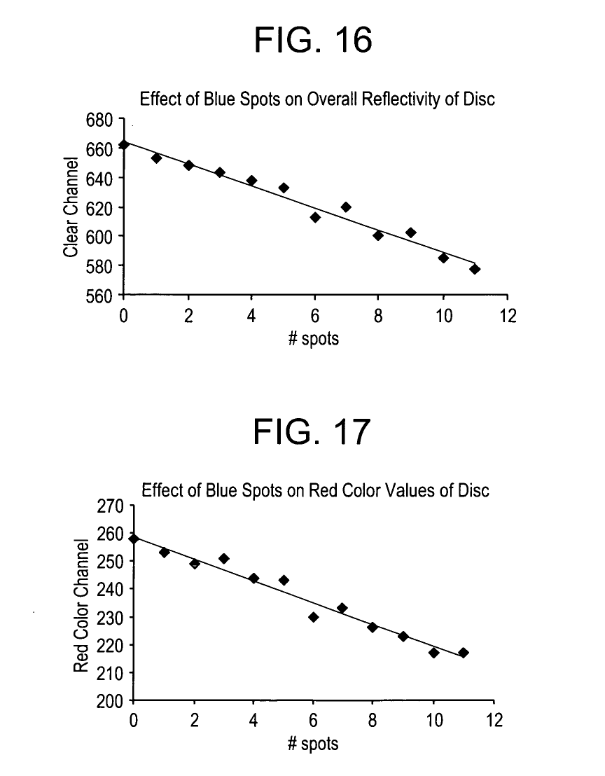

The disk was spotted with the methylene blue/pHEMA solution, one spot at time, and the disk was measured after each spot was added. The graphs of FIGS. 16 and 17 indicate how the red values and reflectivity (clear) values were sensitive to the number of blue spots on the disk. A disk with 11 spots (FIG. 18) was found to have the following RGB values: R=217, B=100, G=196, with an overall reflectivity (using an unfiltered photodiode) of C=577. In this example, the disk spin speed (rpm) and timing frequency of the RGB detector were such that the detector was sampling multiple locations on the disk within the time frame of the measurement; e.g., about 500 to about 2,000 rpm and a detector frequency of 1.8 megahertz (MHz). In one measurement iteration, the detection system automatically sampled multiple points on the disc and returned a result. Without synchronization between the sampling rate and the rotational speed, the measurement is an average reading at a radius. The resulting color information represents the average color at that measurement (radial) band on the disk.

### Example 4

### Detection of Markings and Randomness Level

In a prophetic example, the sampling frequency of the color detector and spin rate of the disk can be synchronized so that the detector can obtain the color at a specific angular (and radial) location on the disc, allowing it to acquire the color of individual spots on the disk. Furthermore, a timing interval (offset) could be adjusted between subsequent acquisitions in order to obtain color information on multiple spots located at various angular positions on the disk. This detector could then be used to quantify the randomness of colored spots on the disk (as coatings, or as in-molded spots in the polycarbonate substrate). In one embodiment, an optical drive could be modified with an array of RGB sensors to obtain color information at a multitude of radial bands.

The use of a random marking enables identification and optionally tracking of a specific article. The random marking can be used to associate the disk with a serial number, code, or other identifier that can confirm the authenticity of the particular disk and even track its use (e.g., purchase, playing, transfer, etc.). Such tracking can enable the identification of unauthorized uses, copying, and the like.

### Example 5

### Detection of Markings and Randomness Level in an Optical Drive

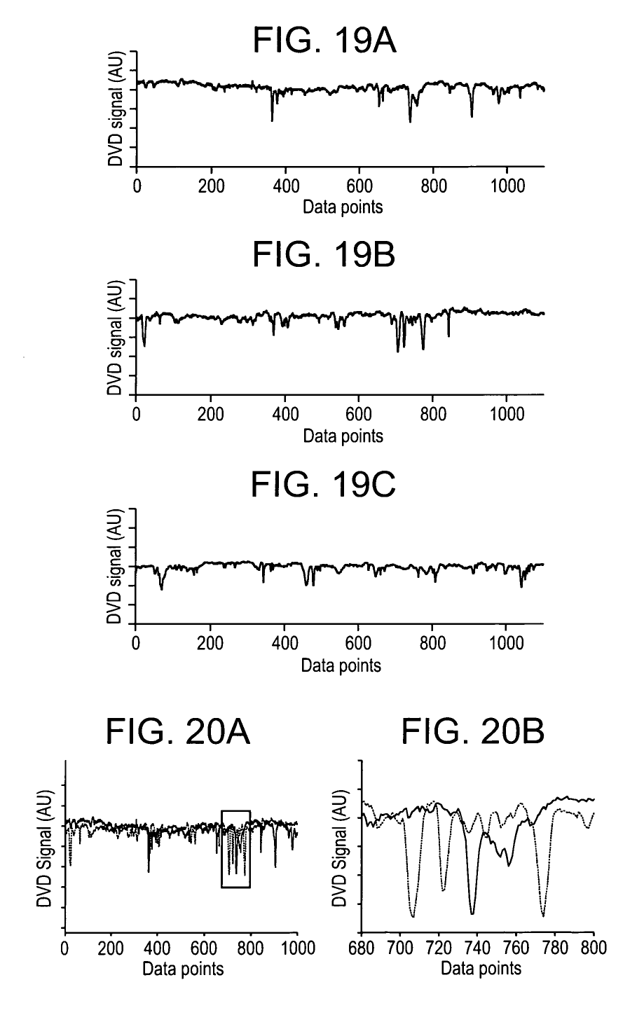

DVDs described in Example 2 were measured in an optical drive such as that described in U.S. Patent Publication No. 2005/0111000, published May 26, 2005. Measurements were performed of multiple DVDs at different radial distances from the center. These measurements were done to demonstrate the uniqueness of the distribution in each DVD at each at radial distance. Unique features of several representative DVDs are presented in FIG. 19, where measurements were performed using the optical drive at the smallest radial position of the DVD laser. Comparison of signatures from two DVDs is presented in FIG. 20, illustrating the details of the uniqueness of the signatures.

More comprehensive identification of details of the individual signatures can be accomplished with a multivariate marking recognition of these signatures. In this way, a multidimensional signature map can be constructed. Pattern recognition and visualization can be done using visualization and pattern recognition algorithms. Graphing and fitting comprise the two components of visualizing the structure of a data set. Pattern recognition and visualization algorithms are mathematical techniques that perform the graphing or fitting of data. For multivariate data sets such as those provided from the DVD signatures, techniques that compress and extract data are particularly useful. For example, principal components analysis (PCA) finds linear combinations of the original variables to construct a new, lower dimensional coordinate system for the graphing and plotting of data. Non-linear mapping (NLM) provides another visualization tool for graphing multidimensional data sets. NLM is based upon a point mapping of the original data to a lower dimensional space such that the inherent structure of the data is approximately preserved under the mapping. Other techniques that can be used for multivariate visualization of data include multidimensional scaling, correspondence factor analysis, and Kohonen's self-organizing map neural network. Visualization and improvement in the quality of signature determinations can be also performed by applying mathematical tools that retain signature features while removing noise. An example of such tools is wavelet analysis.

Among these choices of algorithms, PCA is preferred in this application because of its signal-averaging benefits and its ability to uncover anomalous patterns in the data structure (e.g., an outlier). However, the other approaches, described above, could be used by those of ordinary skill in the art. The PCA method was used to provide a pattern recognition model that correlated the signature features with an individual DVD. The correlation of the variation in these signature descriptors with the individual DVDs can be performed by analyzing the PCA scores using Euclidean distances or other known analysis parameters.

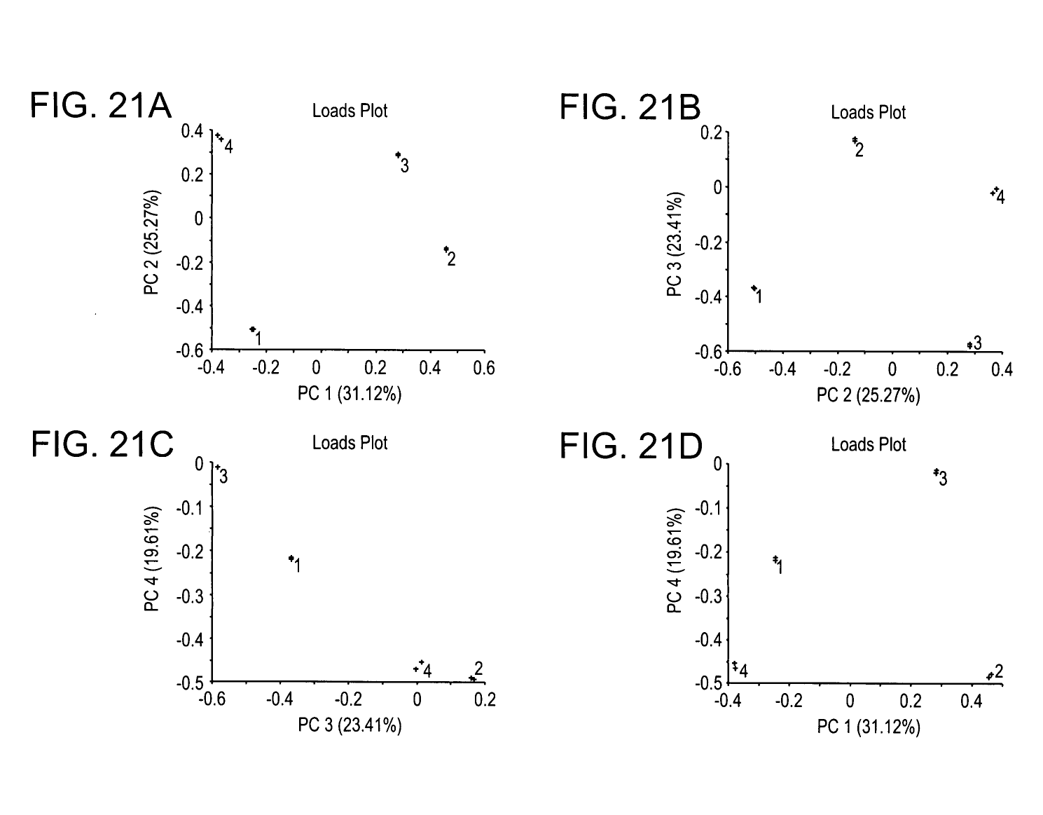

It is also possible to obtain the unique DVD signatures not only from the initial laser position but also from other radial locations. FIG. 21 (obtained using PCA) shows an example of pattern recognition of signatures in one DVD where measurements were performed from four different radial positions. This data illustrates that signatures at different radial positions provide additional unique features. These features can be combined with the features associated with the smallest radial laser position.

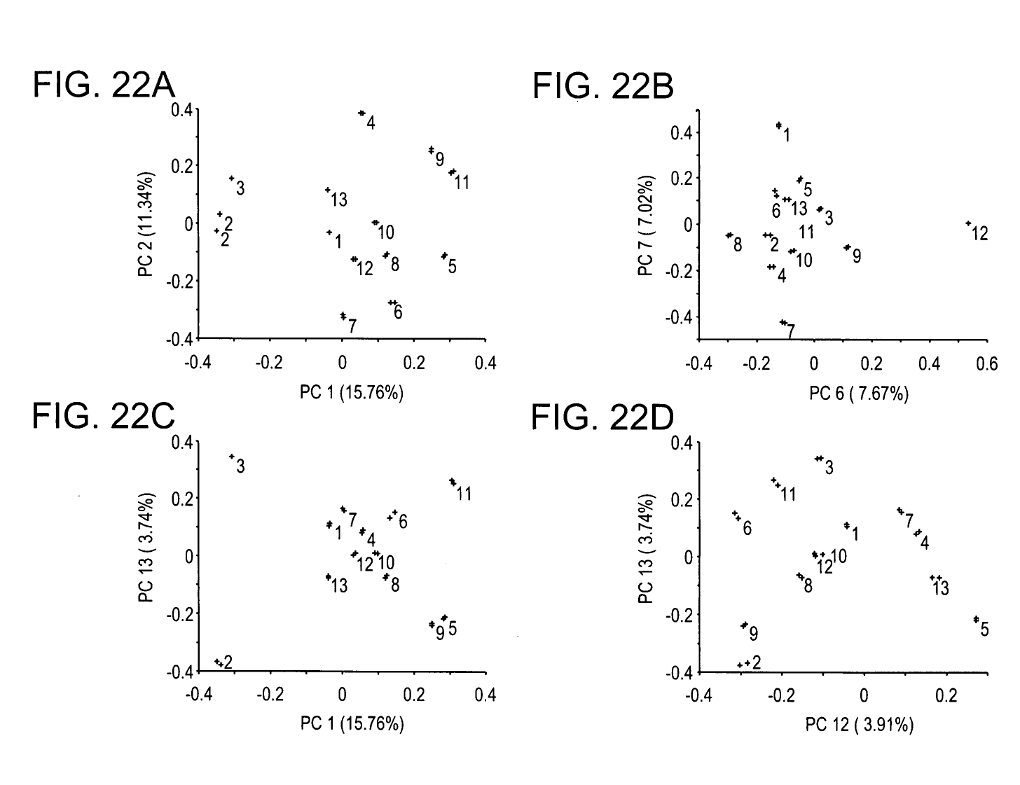

FIG. 22 demonstrates results of the PCA analysis of 13 DVDs measured at the initial laser location position. Four score plots demonstrate the uniqueness of the markings when individual principal components are plotted against each other.

Security, tracking, and control of storage media can suggest marking the media in a consistent, known manner in order to attain uniformity and reproducibility, thus enabling a manufacturer, for example, to identify and track authentic media. Enabling the identification of authentic media also enables the identification of counterfeit media and the ability to inhibit use thereof. In other words, all media from a particular manufacturer can be marked in a consistent, predictable, reproducible manner such that all media from that manufacturer can be associated with that manufacturer. In a sense, the manufacturer can “label” all of their media with their own “label”.

In the randomly marked media, there is no predictability or control of the marking (e.g., distribution of the colorant). The colorant distribution is random, with the non-homogeneity being a sought after characteristic. As a result, each individual medium is unique. Once formed, the non-homogenous disk can be mapped (e.g., the locations of the colorant can be determined and saved so that the specific disk can be identified in the future). This mapping can optionally be done during the disk production/testing and a code/special identifier can be generated. The authentication can then be performed prior to enabling access to the data and/or allowing the installation of the software located on the disk. It is also conceivable to tie the code to an activation code that the end user needs to enter in order to install or access the software. Ideally, the program would authenticate the disk, based upon the prior mapping information, during installation and prior to and/or during use to verify authenticity of the disk.

It is noted and envisioned that the media can comprise an additional tag(s), identifier(s), and/or mark(s). For example, a manufacturer many desire to place their “label” on a media to have an additional technique for identifying that particular disk.

While the invention has been described with reference to a preferred embodiment, it will be understood by those skilled in the art that various changes may be made and equivalents may be substituted for elements thereof without departing from the scope of the invention. In addition, many modifications may be made to adapt a particular situation or material to the teachings of the invention without departing from essential scope thereof. Therefore, it is intended that the invention not be limited to the particular embodiment disclosed as the best mode contemplated for carrying out this invention, but that the invention will include all embodiments falling within the scope of the appended claims.

What is claimed is:

1. An article, comprising:
a random distribution of markings within a substrate, wherein the substrate was formed a first plastic and a second plastic, wherein the first plastic and the second plastic comprise a sufficient difference in a property to cause the random distribution; and
machine readable data and/or a data layer capable of comprising machine readable data.

2. The article of claim 1, wherein the substrate comprises data disposed in a surface of the substrate.

3. The article of claim 1, comprising the data layer and further comprising
a reflective layer, wherein the reflective layer is disposed between the substrate and the data layer; and
a protective layer, wherein the reflective layer is disposed between the protective layer and the substrate.

4. The article of claim 1, further comprising an identifier, wherein the identifier is associated with the random distribution of markings.

5. The article of claim 4, wherein the identifier is a serial number.

6. The article of claim 1, wherein the difference in the property comprises a difference in melt flow rate of greater than or equal to about ±30 g/10 min (at 300° C. using a 1.2 kg load in accordance with ASTM D1238-01e1/ISO 1133-1991).

7. The article of claim 1, wherein the difference in the property comprises a difference in M_{w} of greater than or equal to about ±5,000 amu.

8. The article of claim 1, wherein the difference in the property comprises a difference in glass transition temperature of greater than or equal to about ±30° C.

9. The article of claim 1, wherein the markings are formed from a spectroscopic material.

10. The article of claim 1, wherein the article is a data storage disk and wherein the markings are formed from a tag that is detectable at a laser wavelength used to read from and/or write to the data storage disk.

11. The article of claim 1, wherein the markings are formed from a material selected from the group consisting of fluorophores, nanoparticles, and combinations comprising at least one of the foregoing, wherein the material has an optical signature at greater than or equal to 1 wavelength.

12. The article of claim 11, wherein the material comprises semiconductor nanoparticles.

13. The article of claim 1, wherein the article selected from the group consisting of information articles and personal identification articles.

14. The article of claim 13, wherein the article selected from the group consisting of a license, a visa, a credit card, a debit card, a passport, a membership card, an employment identification card.

15. A method for fabricating an article, comprising:
combining a taggant with a first plastic to form a tagged plastic;
molding the article from the tagged plastic and a second plastic, wherein the article comprises a random distribution of the taggant; and
mapping taggant in the article to form a map.

16. The method of claim 15, further comprising associating an identifier with the map.

17. The method of claim 15, wherein the first plastic and the second plastic comprise a difference in M_{w} of greater than or equal to about ±5,000 amu.

18. The method of claim 15, wherein the first plastic and the second plastic comprise a difference in glass transition temperature of greater than or equal to about ±30° C.

19. The method of claim 15, wherein the article is a data storage medium, wherein the random distribution of the taggant is within the substrate, wherein the taggant is detectable at a read laser wavelength, and further comprising disposing data and/or a data layer on a side of the substrate.

20. The method of claim 15, further comprising disposing the tagged plastic and the second plastic in an extruder, and extruding plastic comprising the random distribution.

21. The method of claim 15, wherein molding the article further comprises introducing the second plastic and the tagged plastic to a mold without actively mixing the second plastic and the tagged plastic prior to the introduction to the mold.

22. A method for fabricating a data storage medium disk substrate, comprising:
combining a taggant with a first plastic to form a tagged plastic; and
molding the disk substrate from the tagged plastic and a second plastic, wherein the disk substrate comprises a random distribution of the taggant, and wherein the taggant is detectable at a laser wavelength used to read from and/or write to the data storage disk.

23. The method of claim 22, further comprising disposing a data layer between the protective layer and the substrate, and disposing a reflective layer between the data layer and the substrate.

24. The method of claim 22, further comprising mapping the taggant to form a map and associating an identifier with the map.

25. A method for authenticating an article, comprising:
illuminating the article, wherein an authentic article comprises a random distribution of markings whose locations have been mapped, wherein the markings are detectable at a wavelength, and wherein the article is illuminated at the wavelength; and
if an emission is detected, comparing the detected emission to the map to determine if the article is authentic.
